(19) United States
(12) Patent Application Publication
(10) Pub. No.: US 2011/0258084 A1
(43) Pub. Date: Oct. 20, 2011

(54) SINGLE WINDOW BASED E-COMMERCE BUSINESS TRANSACTION

(76) Inventor: Allen Keith Watts, Lake Mary, FL (US)

(21) Appl. No.: 13/169,080

(22) Filed: Jun. 27, 2011

Related U.S. Application Data
(63) Continuation-in-part of application No. 12/640,177, filed on Dec. 17, 2009.

(51) Int. Cl. G06Q 30/00; G06Q 50/00

(52) U.S. Cl. 705/27.1

(57) ABSTRACT

The present invention relates to a single window e-commerce based business to consumer transaction with a common inventory database, where an end user can access multiple automobile parts and dealers' product catalogue by accessing a single webpage, and making purchases online without bothering to login again and again and to physically visit each dealer's location and checking his inventory for the desired product, since if the dealer does not have a product in his inventory, he can order it from the OEM.

### CROSS-REFERENCE TO RELATED APPLICATIONS

This application is a continuation-in-part of U.S. patent application Ser. No. 12/640,177 filed on Dec. 17, 2009, entitled SINGLE WINDOW BASED E-COMMERCE BUSINESS TRANSACTION, the full disclosure of which is incorporated herein by reference.

### TECHNICAL FIELD OF THE INVENTION

The present invention relates to an e-commerce based business transaction. More specifically, it relates to a method, system and a database to facilitate an e-commerce transaction through a single window made available online to a plurality of sellers.

### BACKGROUND OF THE INVENTION

Recent advancements in Information Technology have largely re-defined the way conventional shopping was accomplished. The modern day buyer does not need to physically check in at the shops to purchase item(s) of his choice. The online tools available have also given the buyer the option to chose from a range of products, coming from different manufacturers and then to select the one(s) he needs to buy and make purchase accordingly. Such online tools have been popularized in the market through players like Amazon.com and Ebay.com.

While various hostings like http://www.ebay.com, http://www.lavictoriaparts.com have been quite successful for products like books and gift items, for a certain category of products, like automobile parts and accessories, it is imperative for a customer to get the product of the right make and through the right dealers authorized to sell the desired product. This routinely involves the task of individually locating and connecting to such dealer, enquire about the suitable product and then get the entire sell process executed. In case, the desired product is not available at that dealer, the whole process needs to be re-done again.

Therefore, there is a need to develop such method and system and a database to allow a customer to remotely connect to multiple dealers selling the same class/make of products and purchase the product using available online methods irrespective of what is available in the dealer's real-time inventory. Such method and system of online purchase and database must also allow the dealers to put their product catalogue in a web-format of their choice and shipping and other logistics arrangements to their convenience.

### SUMMARY OF THE INVENTION

The present invention can be seen as a multi tenant e-commerce solution with a common inventory database. The method and system of the present invention offers one-stop solution for customers looking, particularly, for automobile parts and accessories. The present invention creates, maintains and stores a database, configured to store parts and accessories data. The database is based on third party parts data. This third party data is converted into an internal format specific for a website. This third party data is of a varying quality and must be updated with data from dealers' computer systems to be up to date. The dealers can access and update data through a backend tool provided as the Admin section. This backend tool is further available with the dealers to customize their storefront/ catalogue. The method and system of the present invention further provides a hosting between dedicated automobile parts dealers and their prospective customers. In this Business-to-Consumer methodology, at the customer hosting, an option to choose the vehicle's parts and/ or accessories of particular make and model is provided, which directs the customer to a database containing a dedicated dealers' list offering the parts and accessories for said make and model. A single window is made available online to a plurality of sellers and Hyperlinks are provided at against each dealer's name which directs the customer to the dealers' dedicated homepage wherein the customer can select and make an online purchase of the product, whether or not the dealer's inventory supports it, since if the dealer does not have that product in his inventory, he can order it from the OEM. The present invention provides the dealers with a database of current car parts and accessories, lets customer order these parts online and then the dealer using the web interface processes the order. The actual shipment is done by the dealer. The customer need not to repeat the process again and again for want of parts or accessories from the dealers. In case more number of parts or accessories are required, the customer need not to login again for a new dealer. Instead, “Parts” and “Accessories” options are available on the webpages for selecting more parts.

### BRIEF DESCRIPTION OF THE DRAWINGS

Preferred embodiments of the invention are described herein below with reference to the drawings wherein:

FIG. 1 is a flowchart diagram for an exemplary representation of the database creation and access of said database by dealers.

FIG. 2 is a flowchart diagram for an exemplary representation of the business transaction as achieved through an embodiment of the present invention.

FIG. 3 is a schematic illustration of an e-commerce based transaction system according to an embodiment of the present invention.

FIG. 4 illustrates a screen shot of a hosting webpage according to an embodiment of the present invention.

FIG. 5 illustrates a screen shot of a dealer's list webpage according to an embodiment of the present invention.

FIG. 6 illustrates a screen shot of a dealer's webpage according to an embodiment of the present invention.

FIG. 7 illustrates a screen shot of a product catalogue webpage according to an embodiment of the present invention.

FIG. 8 illustrates a screen shot of a specific product webpage according to an embodiment of the present invention.

FIG. 9 illustrates a screen shot of a ‘shopping cart’ webpage according to an embodiment of the present invention.

### DETAILED DESCRIPTION OF THE INVENTION

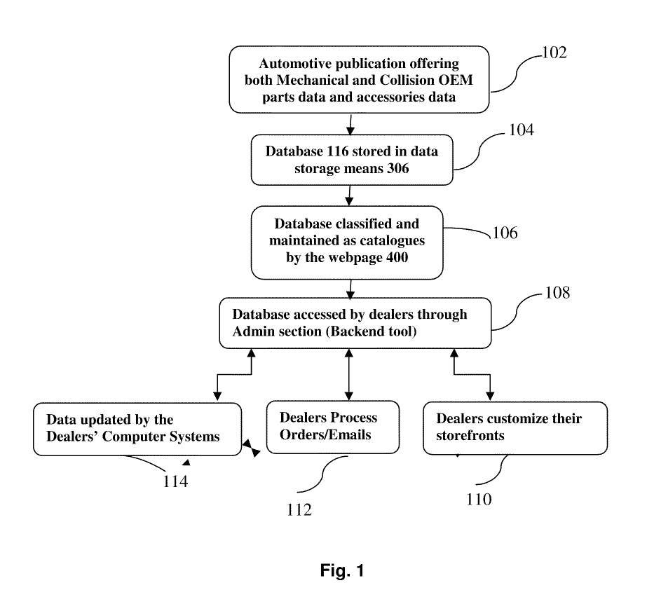

In the present invention, a database 116 is created, maintained and stored in the data storage means 306, configured to store parts data as obtained through an automotive publication offering both Mechanical and Collision OEM parts data and accessories data as represented in Blocks 104 and 102 respectively in FIG. 1. The database is based on third party parts and accessories data. This third party data is converted into an internal format specific for a website. This third party data is of a varying quality and must be updated with data from dealers' computer systems at Block 114 to be up to date. Dealers use Admin section as their backend tool to update data, as shown in Block 108. By combining the data from the dealers with the base third party data the quality of the data is upgraded which adds value to the dealers using it. The data in the database is maintained by the staff on a monthly basis. This maintenance consists of updating the data in the database from the various sources such as new third party base data along with data from the dealers. This monthly data comes in various formats and algorithms have been developed to parse this data and to make sure it is updated in a correct way. This can be seen as using proprietary algorithms to clean data from various sources so it fits into the data model that is being provided to the different dealers by virtue of this invention. The database is further classified and maintained as catalogues by the webpage 400 as shown in Blocks 106 and 216.

The dealers are not given access to this data directly. Backend tool is available with the dealers to access this data. Dealers get a hosted e-commerce solution that is based on this data. They get all the part numbers, schematics and a suggested cost and list price. The dealers can then set their own prices using different methods such as using cost+20%, list price−10% or set individual prices per part. Since there can be up to 350,000 parts or more for one make it's not feasible to set individual prices on each part and it is therefore very useful to set the price based on the list/cost suggestions supplied by the database which is set individually per e-commerce store. At Block 112, dealers Process orders/emails through the admin section. At Block 110, they can also set their own price discounts, shipping methods, policies, design (color, banners, content etc.), run specials, sales tax. They can create custom pages and setup coupons. They can also create custom designed entry pages (splash page) for example—factorymopar.com.

In one embodiment of the invention, a prospective customer (hereinafter also referred to as end user), who intends to look for or buy a desired automobile part(s) or accessories, first logs onto the hosting webpage 400 to select from a list of available automobile ‘makes’ and models, his make and model of choice through the selection means. Once such a choice is done, the end user is directed to a dealers' list webpage 500 having a list of dealers who are authorized to sell the parts and accessories of the selected automobile make and model. Herein, on selecting any particular dealer, the end user is directed to a dedicated webpage 600 of that dealer detailing his product catalogue i.e. retrieved data 608 and contact details, etc retrieved from the data storage means 306 by the data retrieval means 308. The dealer homepage 600 is hosted on the same internet webpage 400. The end user can select his product of choice from the product catalogue add all such product(s) selected in the ‘shopping cart’ provided at the homepage through order taking means 310. The products are finally purchased through payment means 312 using the payment gateways option available on the said dealers' homepage.

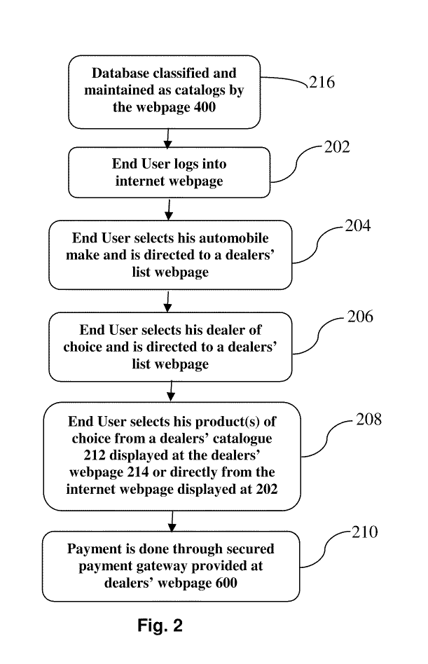

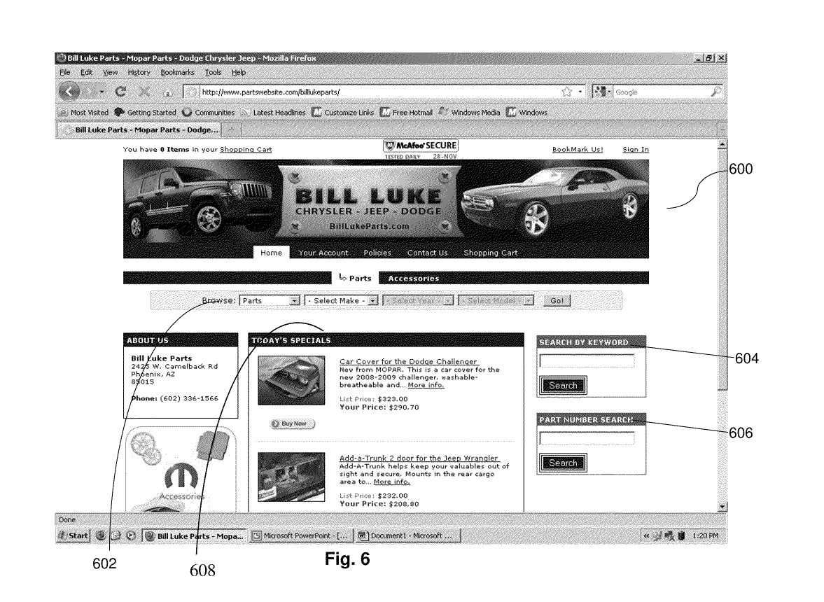

In one embodiment of the present invention, the data so obtained from the respective sources are further classified and maintained as catalogs by the webpage 400. Further in FIG. 2, the different steps of accomplishing a shopping activity according to an embodiment of the present invention are shown. At block 202, an end user logs onto an internet webpage 400 to access multiple dealers product catalogue for a specific automobile make. The webpage 400 displays a list of automobile brands for which dealers' information is stored in the database of webpage 400. At Block 202, End user logs into the internet webpage, compulsorily, from the login Account created at homepage 400. If the customer needs some more parts, he need not to login again for a separate dealer. For this, “Parts” and “Accessories” options are available at the webpages 600, 700, 800, 900 in FIGS. 6, 7, 8 and 9 respectively.

At block 204, user selects his automobile make and is directed to a dealers' list webpage 500. The webpage 500 displays a list of dealers authorized to sell automobile parts and accessories pertaining to that particular make that the user has selected.

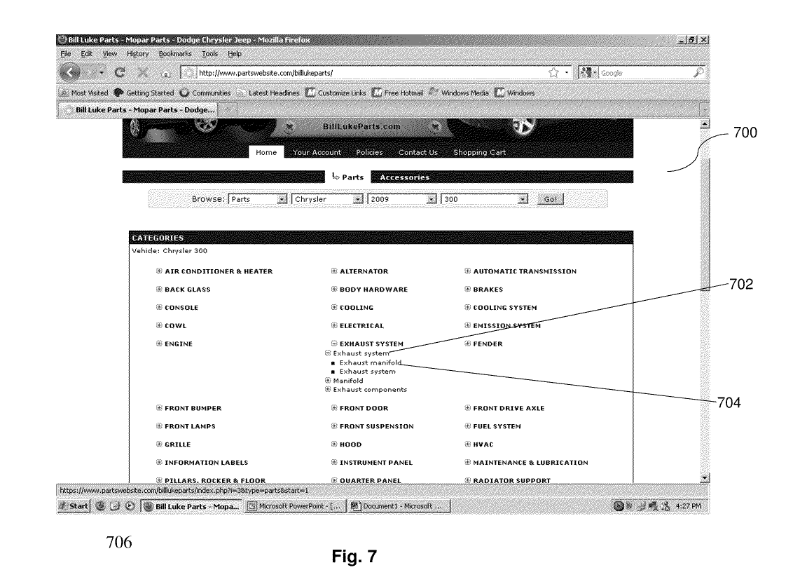

At block 206, user selects, from amongst the list of dealers as displayed at block 204, his dealer of choice and is then directed to said dealer's webpage 600 that contains retrieved data on an end user hosting means, exemplified as 608. The display at webpage 600 provides the user an option to choose a model, make and year of make of the automobile for which he is looking for parts and/or accessories and then accordingly, a relevant product catalogue 706 with subcategories as 702 and 704 is displayed, as is shown in FIG. 7.

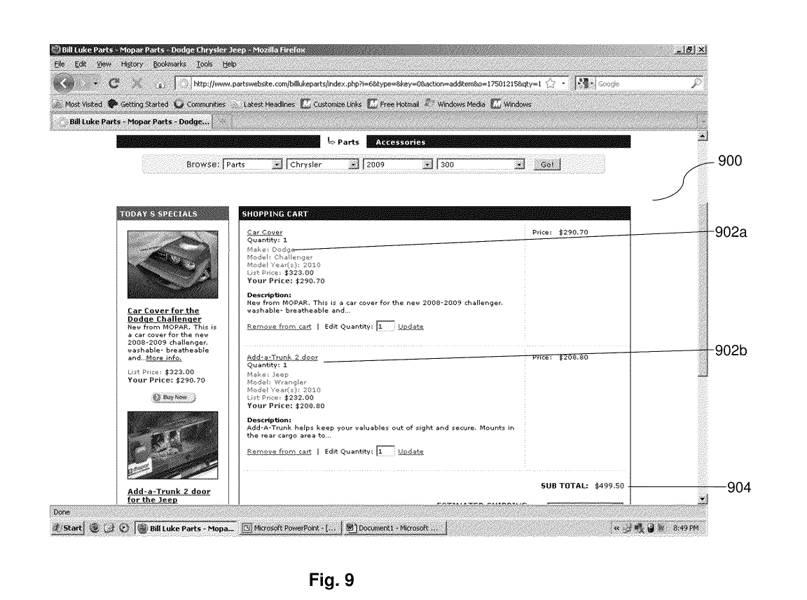

At block 208, in an embodiment, user selects the product(s) which he intends to purchase from the dealers' catalogue, displayed at dealer's webpage 214, as illustrated at 706 and 212 in FIGS. 7 and 2 respectively, and add it to a ‘shopping cart’ option displayed at the webpage 600. The ‘shopping cart’, as displayed in FIG. 9, is an order taking means associated with the webpage 600.

At block 210, purchase of the product(s) added to the shopping cart is made through secured payment gateway. The actual working of such payment gateways is through a payment means.

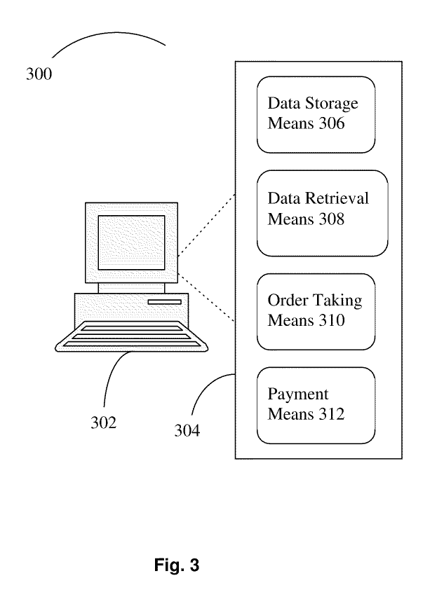

Referring to FIG. 3, a system 300 according to a preferred embodiment of the present invention can comprise an end-user hosting means 302, preferably in the form of a computer terminal which hosts the webpages 400, 500, 600, 700, 800 and 900. The server 304 of the webpages further comprise a data storage means 306, a data retrieval means 308, an order taking means 310 and payment means 312. The functional aspect of these system components shall be discussed later.

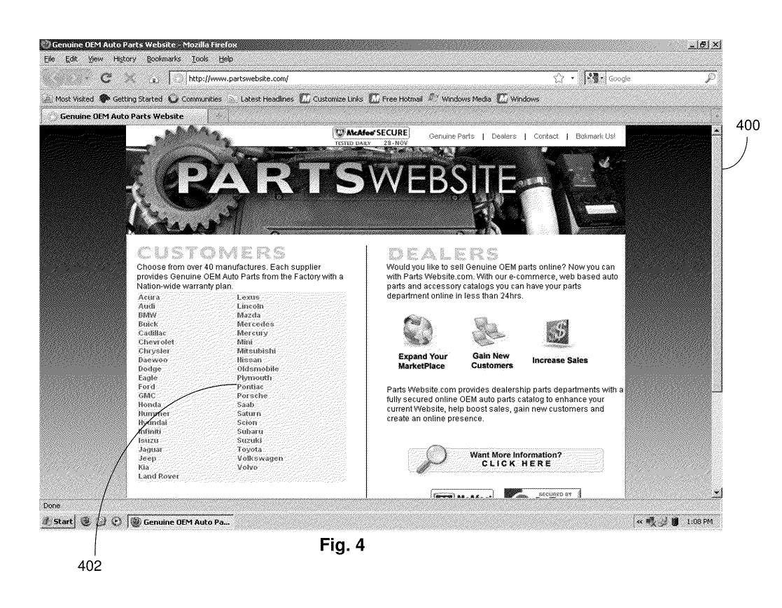

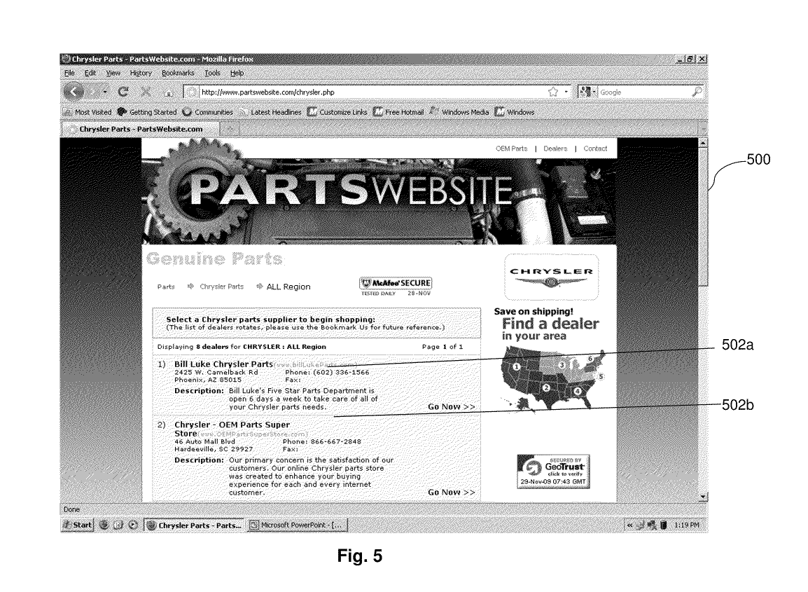

In one aspect of the present invention, the hosting webpage 400 allows an end user to simultaneously access the product catalogues of dealers physically located at remote locations. In an embodiment of the invention, the webpage 400 could be accessed through an end-user hosting means including, for example, a computer terminal, a mobile phone or the like which offer such a hosting to establish an internet communication network. In yet another embodiment of the invention, the webpage 400 contain the database wherein the dealer data is segregated primarily on the basis of a particular automobile make for which the dealers are authorized to sell the parts or accessories, though, other basis of segregation too can be designed and implemented. As shown in FIG. 4, on the webpage 400, an end user can browse through a list of automobile brands present at interface 402. The webpage 400 maintain a catalogue of parts and accessories data for each automobile brand as shown at interface 402. In an embodiment of the invention, an end user has the option to click on his hyperlink available at each automobile brand and is accordingly directed to a different webpage, 500, which, as shown in a representative screenshot in FIG. 5, containing the retrieved data from the data storage means 306 by the data retrieval means 308,

FIG. 5 illustrates a screen shot of a dealer's list webpage according to an embodiment of the present invention. The list of dealers, exemplified as 502a and 502b, presents the name of dealers who have a product catalogue matching to the end user's choice of automobile make. Display of such a dealers list is brought about by a retrieval of data by the data retrieval means 308 from the database associated with the webpage 400. Optionally, a brief description of products provided by the dealer or communication details such as mobile number, telephone, web information can be provided. The retrieval of data is through a retrieval means 308 associated with the webpage 400. The retrieval means is configured to look for the item searched in the database and accordingly return the item that matches the search criteria. Such retrieval is preferably not random and thus the same search term at each time might list the same result in exactly the same sequence as obtained in an earlier similar search. Each of the listed dealers has a separate homepage hosted on the webpage 400 and which can be accessed by an end user by clicking on the hyperlink that appears with the dealer names on the dealer's list webpage 500. A backend tool is available for dealers to customize their storefront/catalog. Thus, the dealers can set up their own discounts, policies, store colors, banners etc.

FIG. 6 illustrates a screen shot of a dealer's webpage according to an embodiment of the present invention. The webpage 600 comprise of information related to, but not limited to, a product catalogue representing the products on offer and their respective price detail, contact details of the dealer and other details which the dealer might find useful to put for the benefit of end user. To facilitate an easier browsing, in an embodiment of the invention, it is provided that the user enters his choice of ‘parts’ or ‘accessories’ that he is looking for. This feature is represented as icon ‘Browser’ present at location 602 at the webpage 600. The icon at 602 given an end user the option to select either ‘parts’ or ‘accessory’ depending on his exact query. Further, the end user selects, from a drop down menu at next tabs, his choice of automobile, make, year and model, so that a dedicated and efficient search is made which retrieves the most relevant results for the end user, thus saving the user much hassle and time in browsing through a complex data mesh to reach to his product(s) of choice. The webpage 600 further gives an end user an option to do a customized search by ‘keyword’, as shown in 604, or by ‘part number’, as shown in 606. This retrieves the relevant hit to the end user in a single click unlike the ‘Browse’ option where he is directed to a dedicated webpage with an option to select the broad ‘parts category’ first and then the specific part within the said broad parts category, as discussed in detail in FIG. 5.

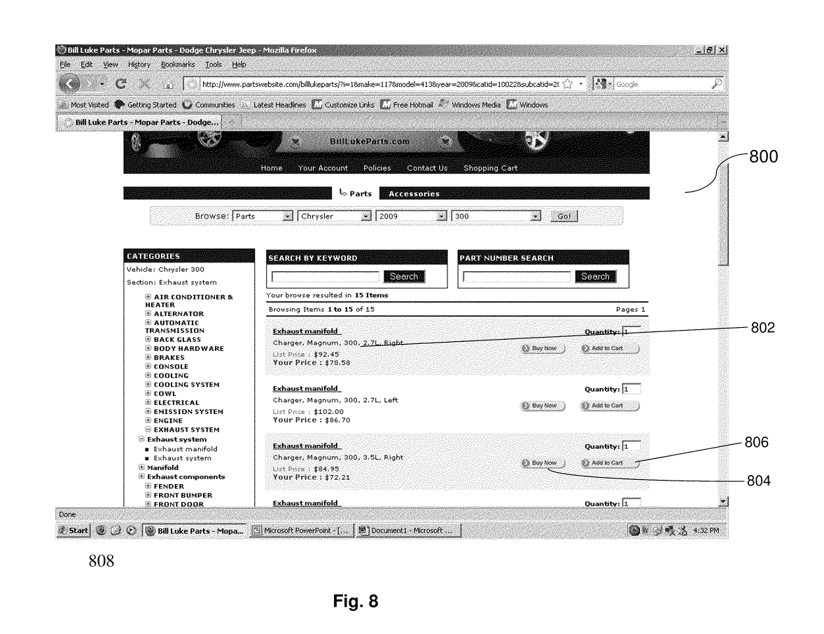

FIG. 7 illustrates a screen shot of a product catalogue webpage according to an embodiment of the present invention. The list of products catalogue is provided when a particular query is entered in the ‘Browse’ option. FIG. 7, thus, represents a case where an end user is looking for an automobile ‘part’ for a Chrysler 300 model of 2009 make. The display, as shown at 700, is a list of various categories of parts available for that particular model and make. 702 and 704 are particular product subcategories that are displayed when end user clicks on a product from the list of products catalogue 706. An end user can select his ‘parts’ of choice and depending on the ‘parts’, be further directed to a sub-list containing specific parts. An end user can then select the particular product of his choice and be directed to the specific product webpage as shown in FIG. 8.

FIG. 8 illustrates a screen shot of a specific product webpage according to an embodiment of the present invention. The webpage 800 includes the information about the price and other product details, represented at 802, exemplified retrieved seller data for the particular selected product. It also provides an option to the end user of either buying the product at 804, or to add the product to the shopping cart, at 806, if he intends to do more shopping and wishes to be billed together. Product catalogue 808 is also displayed on the left hand side on webpage 800 so that an end user can select more products on the same webpage.

FIG. 9 illustrates a screen shot of a ‘shopping cart’ webpage according to an embodiment of the present invention. The shopping cart webpage 900 displays the list of products, 902a and 902b. The cumulative total price that the user incurs is displayed at 904. In an embodiment of the invention, the shopping cart has an order taking means associated with it wherein the said order taking means is configured to function over a communication network, preferably an internet communication network, to take and record the various products that the end user selects in course of his shopping at the webpage 400. The order process starts when a customer visits the e-commerce site. The customer then locates the parts it wants by either choosing the make/model/year and then gets shown a 3 level deep category tree of parts. The parts are then shown by their name and mechanical sketches in “View Illustrations” tab, to make to identify the part they require. Once the correct part is found the customer can add that to their shopping cart and perform to checkout. The checkout process is a regular one, getting address, shipping address and credit card info. It also requires the VIN so the dealer can double-check that the ordered part will fit. Once checkout is completed an order is created that the dealers need to fulfill. The orders are assigned different statuses depending on where in the fulfillment process it is. This lets the dealer keep track of the orders as they flow through the system. Once the order is shipped from the dealer the order gets assigned the status “shipped” and the order is considered to be completed.

In an embodiment of the invention, to successfully accomplish the payment procedure, a user has to create a ‘login’ account at the homepage 400. It not only secures his payment but also make it easier for him to manage and keep a track of the shipped product etc. In an embodiment of the invention, the payments are made through payment means associated with the webpage 400 and configured to function over a communication network, preferably an internet communication network. The payment is accomplished through secured payment gateways. User gives billing information during checkout and dealer charges user. Some dealers also use PayPal and payment gateways—others bill them manually like a walk in customer.

The procedure contained in the present invention works in a simple manner. Dealer simply adds a link on his website linking to the catalog and the parts department is online Applicants design the catalog using the dealer's extensive website, colors, logos, banners etc. or the dealers may choose to use the catalog as a standalone auto parts site. Dealer's customers can search for parts and accessories by year, make, model-keyword or part number search. When an order or message is placed, dealers are notified via email to login to their admin section where all information is in secured environment. The administration login also provides tools to customize their catalog. Dealers have the ability to change discounts, shipping methods, billing options, gateways, policies, design etc. A distinct advantage provided by the embodiments of the present invention is that the webpage 300 enlists a detailed products list for each automobile make and model, irrespective of whether they are available in the current inventory of the respective dealer or not. This gives the dealers a chance to sell all of manufacturer's products, independent of whether his current inventory supports it or not, since, if the dealer doesn't have that product in his inventory, he can order it. It will be understood that various modifications can be made to the embodiments of the present invention herein disclosed without departing from the spirit and scope thereof. Therefore, the above description should not be construed as limiting the invention but merely as exemplifications of preferred embodiments thereof. Those skilled in the art will envision other modifications within the scope and spirit of the present invention as defined by the claims appended hereto.

I/we claim:

1. A method for facilitating a single window e-commerce enabled transaction related to automobile parts and accessories, said method comprising the steps of:
storing a plurality of data in a database of a hosting webpage, wherein the database is created and stored in a data storage means configured to store parts data and accessories data coming from the respective manufacturers;
providing the database to a plurality of dealers wherein the dealers can access data through a backend tool;
retrieving one or more of the data from the database at the option of an end user and displaying retrieved data on an end-user hosting means;
selecting a dealer from the retrieved data;
selecting one or more of the retrieved parts or accessories data;
ordering the selected parts or accessories data through a communication network connected with the end-user hosting means; and
paying for the selected parts or accessories data through payment means linked with the end-user hosting means.

2. The method as claimed in claim 1, wherein the end-user can select one or more of the parts or accessories for purchase from the retrieved data.

3. The method as claimed in claim 1, wherein the end-user hosting means comprises a computing means configured to function over a communication network.

4. The method as claimed in claim 1, wherein the retrieving of the data comprises selecting a hypermedia link.

5. The method as claimed in claim 1, wherein the ordering and payment means are associated with the end-user hosting means and configured to function over the communication network.

6. A system for facilitating an e-commerce enabled transaction, said system comprising:
an end-user hosting means;
a database comprising of parts and accessories data;
data access means provided to a plurality of dealers;
data storage and retrieval means associated with a hosting webpage for storing and retrieving at least one of the data from the database;
data selecting means;
means for taking orders related to a selected data; and
means for accepting payment related to the selected data.

7. A database containing the data comprising of Automotive publication offering Mechanical and Collision OEM parts data and the accessories data, said database stored in data storage means located on a server accessed through an end user hosting means.
